(19) United States
(12) Patent Application Publication
(10) Pub. No.: US 2017/0184939 A1
(43) Pub. Date: Jun. 29, 2017

(54) ELECTROPHORETIC PARTICLE, ELECTROPHORETIC DISPERSION LIQUID, ELECTROPHORETIC SHEET, ELECTROPHORETIC DEVICE, AND ELECTRONIC APPARATUS

(71) Applicant: Seiko Epson Corporation, Tokyo (JP)

(72) Inventors: Masahiko Nakazawa, Matsumoto-shi (JP); Takashi Hiraiwa, Fujimi-machi (JP); Hiroki Nakahara, Shiojiri-shi (JP); Harunobu Komatsu, Matsumoto-shi (JP); Kozo Shitagami, Chino-shi (JP)

(21) Appl. No.: 15/376,249

(22) Filed: Dec. 12, 2016

(30) Foreign Application Priority Data
Dec. 25, 2015 (JP) 2015-255352

(51) Int. Cl. G02F 1/167

(52) U.S. Cl. CPC G02F 1/167; G02F 2001/1678

(57) ABSTRACT

An electrophoretic particle includes a base particle and a block copolymer (a particle surface treatment agent) which is bonded to the base particle (a particle), in which the block copolymer includes a dispersion portion derived from one first monomer formed of a siloxane-based compound, and a bonding portion derived from two or more second monomers having a functional group, and is bonded to the base particle with the reaction of the functional group in the bonding portion. In addition, a weight-average molecular weight of the dispersion portion is in a range of 15,000 to 150,000.

### BACKGROUND

1. Technical Field

The present invention relates to an electrophoretic particle, an electrophoretic dispersion liquid, an electrophoretic sheet, an electrophoretic device, and an electronic apparatus.

2. Related Art

Generally, the fact that when an electric field is applied to a disperse system in which fine particles are dispersed in a fluid, the fine particles move (migrate) in the fluid by Coulomb's force has been known. This phenomenon is called electrophoresis, and recently, an electrophoretic display device which displays desired information (an image) by using the electrophoresis has attracted attention as a new display device.

Such an electrophoretic display device has display memory properties and wide viewing angle properties in a state of stopping the application of voltage, and is capable of performing high contrast display and low power consumption.

In addition, the electrophoretic display device is a non light-emitting type device, and thus is easy on the eyes as compared with a light-emitting type display device such as a cathode-ray tube.

It has been known that such an electrophoretic display device includes a liquid which disperses the electrophoretic particles in a dispersion medium as the electrophoretic dispersion liquid disposed between a pair of substrates having electrodes.

In the electrophoretic dispersion liquid of the above-described configuration, a positively charged particle and a negatively charged particle are used as the electrophoretic particle, and thus it is possible to display desired information (image) by applying a voltage across a pair of substrates (electrodes).

As the aforementioned electrophoretic particle, typically, a particle having a coated layer in which a polymer (coupling agent) is bonded to a base material particle is used, and with such a configuration of having the coated layer (polymer), it is possible to disperse and charge the electrophoretic particles in the electrophoretic dispersion liquid (refer to JP-A-2015-14776).

In the above-described electrophoretic particle contained in the electrophoretic dispersion liquid, in a case where a hydrolyzable group to be bonded via a single silicon atom contained in a coupling agent and a surface of the base particle are subjected to a dehydration condensation reaction such that the coupling agents are bonded, the obtained electrophoretic particles are aggregated with each other and are adhered to the electrode surface. As a result, there is a problem in that degradation of the contrast (the property of reflectance) is caused.

### SUMMARY

An advantage of some aspects of the invention is to provide an electrophoretic particle exhibiting excellent contrast (the property of reflectance) in an electrophoretic dispersion liquid, an electrophoretic dispersion liquid, an electrophoretic sheet, an electrophoretic device, and an electronic apparatus which use the electrophoretic particle and thus has high reliability.

Such an advantage can be achieved in the following aspects of the invention.

According to an aspect of the invention, there is provided a electrophoretic particle including a particle; and a particle surface treatment agent which is bonded to the particle, in which the particle surface treatment agent is a block copolymer which includes a dispersion portion derived from one first monomer formed of a siloxane-based compound, and a bonding portion derived from two or more second monomers having a functional group, and is bonded to the particle with the reaction of the functional group in the bonding portion, and a weight-average molecular weight of the dispersion portion is in a range of 15,000 to 150,000.

With this, the electrophoretic particle is sufficiently dispersed in the electrophoretic dispersion liquid, and thus it is possible to reliably suppress or prevent positive and negative electrophoretic particles from being aggregated with each other and from being adhered to the electrode surface. Therefore, the excellent contrast (the property of the reflectance) is exhibited.

In the electrophoretic particle according to the aspect of the invention, it is preferable that the dispersion portion be formed by bonding the one first monomer to the bonding portion.

With this, the dispersion portion derived from the one first monomer is formed.

In the electrophoretic particle according to the aspect of the invention, it is preferable that the first monomer be a silicone macromonomer expressed by the following Formula (I).

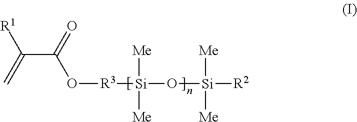

[In the formula, R¹ represents a hydrogen atom or a methyl group, R² represents a hydrogen atom or an alkyl group having 1 to 4 carbon atoms, R³ represents a structure including one of an alkyl group having 1 to 6 carbon atoms and an ether group of ethylene oxide or propylene oxide, and n represents an integer of 180 or greater.]

When such a silicone macromonomer is used as a first monomer, the dispersion portion exhibits excellent affinity with respect to a silicone oil used as a dispersion medium which is contained in the electrophoretic dispersion liquid. For this reason, the electrophoretic particles which include the dispersion portion are dispersed with excellent dispersibility in the electrophoretic dispersion liquid without being aggregated.

In the electrophoretic particle according to the aspect of the invention, it is preferable that the bonding portion be formed by polymerizing the two or more second monomers.

With this, the bonding portion derived from the two or more second monomers is formed.

In the electrophoretic particle according to the aspect of the invention, it is preferable that in the bonding portion, the number of units derived from the second monomer be in a range of 2 to 15.

With this, it is possible to sufficiently perform the bonding to the particle, and thus the electrophoretic particle in which the particle and the particle surface treatment agent are bonded to each other in the bonding portion is reliably formed.

In the electrophoretic particle according to the aspect of the invention, it is preferable that when a weight of the particle is set to be 100% by weight, the weight of the particle surface treatment agent be in a range of 2% by weight to 20% by weight.

In a case where the above range is satisfied, it is possible to disperse the electrophoretic particles in the electrophoretic dispersion liquid with more excellent dispersibility.

According to still another aspect of the invention, there is provided an electrophoretic dispersion liquid including the electrophoretic particle of the invention; and a dispersion medium having a silicone oil as a main component.

The electrophoretic particle is sufficiently dispersed in the electrophoretic dispersion liquid, and thus it is possible to reliably suppress or prevent the positive and negative electrophoretic particles from being aggregated with each other and from being adhered to the electrode surface. Therefore, the problem in that degradation of the contrast (the property of the reflectance) is caused can be solved.

According to still another aspect of the invention, there is provided an electrophoretic sheet including a substrate; and a structure body which is provided on the substrate, and accommodates the electrophoretic dispersion liquid of the invention.

With this, it is possible to obtain the electrophoretic sheet with high-performance and reliability.

According to still another aspect of the invention, there is provided an electrophoretic device including the electrophoretic sheet of the invention.

With this, it is possible to obtain the electrophoretic device with high-performance and reliability.

According to still another aspect of the invention, there is provided an electronic apparatus including the electrophoretic device of the invention.

With this, it is possible to obtain the electronic apparatus with high-performance and reliability.

### BRIEF DESCRIPTION OF THE DRAWINGS

The invention will be described with reference to the accompanying drawings, wherein like numbers reference like elements.

FIG. 1 is a longitudinal sectional view illustrating an electrophoretic particle contained in an electrophoretic dispersion liquid according to a first embodiment of the invention.

FIG. 2 is a schematic diagram of a block copolymer contained in the electrophoretic particle illustrated in FIG. 1.

FIG. 3 is a flowchart illustrating method of manufacturing an electrophoretic dispersion liquid.

FIG. 4 is a diagram for schematically illustrating a longitudinal cross section of the electrophoretic display device of the embodiment.

FIG. 5 is a schematic diagram illustrating an operating principle of the electrophoretic display device illustrated in FIG. 4.

FIG. 6 is a schematic diagram illustrating an operating principle of the electrophoretic display device illustrated in FIG. 4.

FIG. 7 is a perspective view illustrating an embodiment in a case where an electronic apparatus of the invention is applied to an electronic paper.

FIG. 8 is a diagram illustrating an embodiment in a case where the electronic apparatus of the invention is applied to a display.

FIG. 9 is a diagram illustrating an embodiment in a case where the electronic apparatus of the invention is applied to a display.

### DESCRIPTION OF EXEMPLARY EMBODIMENTS

Hereinafter, preferable embodiments of an electrophoretic particle, an electrophoretic dispersion liquid, an electrophoretic sheet, an electrophoretic device, and an electronic apparatus of the invention will be specifically described with reference to the drawings.

First, an electrophoretic dispersion liquid (the electrophoretic dispersion liquid of the invention) containing an electrophoretic particle of the embodiment of the invention will be described.

### Electrophoretic Dispersion Liquid

The electrophoretic dispersion liquid contains at least one type of electrophoretic particles 1, and a dispersion medium (a liquid phase dispersion medium), and in the electrophoretic dispersion liquid, the electrophoretic particles 1 are dispersed (suspended) in the dispersion medium.

### Electrophoretic Particle

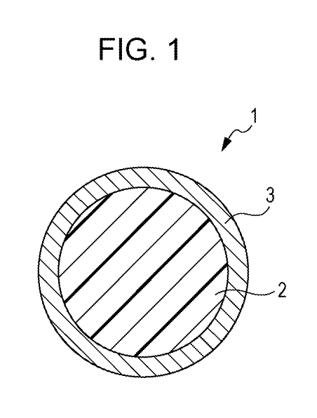

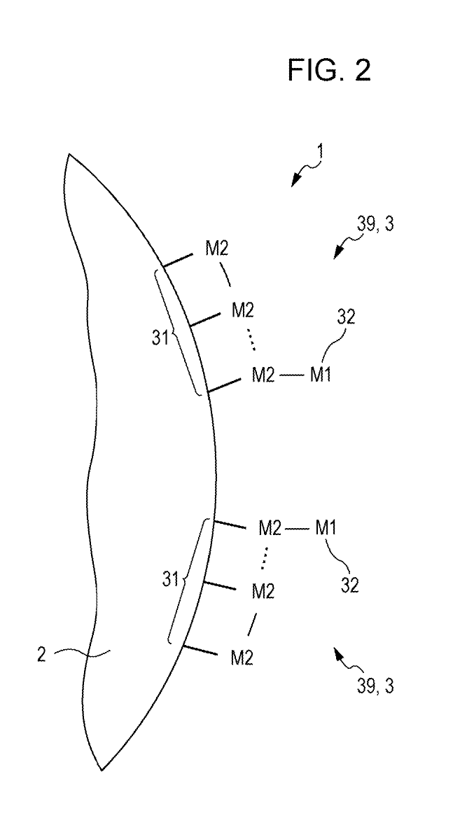

FIG. 1 is a longitudinal sectional view illustrating a first embodiment of the electrophoretic particle contained in an electrophoretic dispersion liquid of the invention, and FIG. 2 is a schematic diagram of a block copolymer contained in the electrophoretic particle illustrated in FIG. 1.

As illustrated in FIG. 1, the electrophoretic particle 1 includes a base particle (particle) 2 and a coated layer 3 provided on a surface of the base particle 2.

As the base particle 2, for example, at least one of a pigment particle, a resin particle, and a composite particle thereof is preferably used. These particles are easily manufactured.

Examples of the pigment for constituting the pigment particle include a black pigment such as aniline black, carbon black, and titanium black, a white pigment such as titanium dioxide, antimony trioxide, barium sulfate, zinc sulfide, zinc oxide, and silicon dioxide, an azo-based pigment such as monoazo, disazo, and polyazo, a yellow pigment such as isoindolinone, chrome yellow, yellow iron oxide, cadmium yellow, titanium yellow, and antimony, a red pigment such as quinacridone red and chrome vermilion, a blue pigment such as phthalocyanine blue, indanthrene blue, Prussian blue, ultramarine blue, and cobalt blue, and a green pigment such as phthalocyanine green. These pigments may be used alone or in combination of two or more types thereof.

In addition, examples of a resin material for constituting resin particles include an acrylic resin, a urethane resin, a urea resin, an epoxy resin, polystyrene, and polyester. These resins may be used alone or in combination of two or more types thereof.

In addition, examples of the composite particle include a particle obtained by performing a coating treatment in which the surface of the pigment particle is coated with the resin material, a particle obtained by performing a coating treatment in which the surface of the resin particle is coated with the pigment, and a particle composed of a mixture obtained by mixing the pigment and the resin material at an appropriate composition ratio.

Meanwhile, it is possible to set a desired color for the electrophoretic particle 1 by appropriately selecting the type of the pigment particle, the resin particle, and the composite particle which are used as the base particle 2.

In addition, due to the above selection, the positive charging properties or the negative charging properties of the base particle 2, and the charging amount thereof can be set as a unique matter of the base particle 2.

Note that, it is necessary that the base particle 2 includes (exposes) a first functional group which can be bonded to (react with) a second functional group included in a bonding portion 31 of a block copolymer 39 described below on the surface thereof. However, there is a case where the base particle 2 does not include a functional group depending on the type of the pigment particle, the resin particle, and the composite particle, and thus, in this case, the first functional group is introduced to the surface of the base particle 2 by performing in advance a functional group introduction treatment such as an acid treatment, a base treatment, a UV treatment, an ozone treatment, and a plasma treatment.

Meanwhile, the combination of the first functional group which is provided on the surface of the base particle 2, and the second functional group which includes the bonding portion 31 of the block copolymer 39 is not particularly limited as long as the materials can be bonded to each other through the reaction therebetween. For example, examples of the combination include a combination of an isocyanate group and a hydroxyl group or an amino group, a combination of an epoxy group, a glycidyl group or an oxetane group and a carboxyl group, an amino group, a thiol group, and a hydroxyl group or an imidazole group, a combination of an amino group and a halogen group such as Cl, Br, and I, and a combination of an alkoxysilyl group and a hydroxyl group or an alkoxysilyl group. Among them, a combination of the hydroxyl group as the first functional group and the alkoxysilyl group as the second functional group is preferably used.

Both of the base particle 2 having the above combination and a monomer M2 can be relatively easily prepared, and are preferably used since the monomer M2 (a block copolymer described below) can be firmly bonded onto the surface of the base particle 2.

Hereinafter, an example of a combination of the first functional group which is provided on the surface of the base particle 2 as a hydroxyl group with the second functional group provided in the monomer M2 as an alkoxysilyl group will be described.

In the base particle 2, at least a portion (almost the entire surface in the configuration in the drawing) of the surface thereof is coated with the coated layer 3.

The coated layer 3 is configured to include a plurality of the block copolymers 39 (refer to FIG. 2).

The invention specifies the configuration of the block copolymer 39 (hereinafter, simply referred to as a “copolymer 39”), and hereinafter, the configuration of the block copolymer 39 will be described in detail.

The block copolymer 39 includes a dispersion portion 32 and the bonding portion 31 which is bonded to the dispersion portion 32.

The dispersion portion 32 is formed by bonding (polymerizing), one first monomer M1 (hereinafter, simply referred to as a “monomer M1”) having a portion (a group) for contributing to the dispersibility in the dispersion medium to the bonding portion 31, and includes one unit (a constituting unit, hereinafter, referred to as a dispersion unit) derived from the monomer M1.

The bonding portion 31 is formed by polymerizing two or more second monomers M2 of which have an alkoxysilyl group (the second functional group) and is reacted with a hydroxyl group (the first functional group) on the surface of the base particle, and includes two or more (a plurality of) units (hereinafter, referred to as a “bonding unit”) derived from the monomers M2. In the bonding portion 31, when the hydroxyl group and the functional group are reacted with each other, the base particle 2 and the block copolymer 39 are chemically bonded.

In the invention, the aforementioned block copolymer 39 forms a particle surface treatment agent (coupling agent) which is bonded to the surface of the base particle 2.

The dispersion portion 32 is provided on the surface of the base particle 2 in the coated layer 3 so as to impart the dispersibility to the electrophoretic particle 1 in the electrophoretic dispersion liquid.

In the electrophoretic dispersion liquid, the aforementioned dispersion portion 32 is formed by bonding one monomer M1 which includes a portion that becomes a side chain for contributing to the dispersibility in the dispersion medium to the bonding portion 31 after being bonded to the bonding portion 31, and includes one dispersion unit derived from the monomer M1, which is bonded thereto.

The monomer M1 has one polymerizable group such that bonding units included in the bonding portion 31 described below are polymerized (bonded) by the living radical polymerization (the radical polymerization), and is a pendant-type monofunctional monomer (siloxane-based compound) which includes a portion corresponding to a non-ionic side chain after performing polymerization (after reaction).

A silicone macromonomer expressed by the following Formula (I) which has dimethyl polysiloxane as the non-ionic side chain, and a (meth)acryloyl group as the polymerizable group is preferably used as the monomer M1. When such a silicone macromonomer is used as the monomer M1, the block copolymer 39 reliably has a function as a siloxane-based compound.

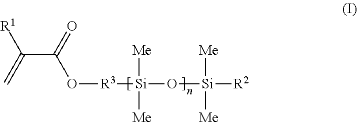

[In the formula, R¹ represents a hydrogen atom or a methyl group, R² represents a hydrogen atom or an alkyl group having 1 to 4 carbon atoms, R³ represents a structure including one of an alkyl group having 1 to 6 carbon atoms and an ether group of ethylene oxide or propylene oxide, and n represents an integer of 180 or greater.]

The dispersion portion 32 formed by using the silicone macromonomer having such a non-ionic side chain as the monomer M1 exhibits excellent affinity with respect to a silicone oil used as a dispersion medium which is contained in the electrophoretic dispersion liquid described below. For this reason, the electrophoretic particles 1 which include the dispersion portion 32 are dispersed with excellent dispersibility in the electrophoretic dispersion liquid without being aggregated. In addition, when the monomer M1 having the (meth)acryloyl group as the polymerizable group is used, the monomers M1 can be polymerized (bonded) with each other with excellent reactivity with respect to the polymerizable group derived from the monomer M2 included in the bonding portion 31 described below, and thus it is possible to easily obtain the dispersion portion 32 which is bonded to the bonding portion 31.

In the dispersion portion 32 of the above-described configuration in the invention, the weight-average molecular weight of the dispersion portion 32 is in a range of 15,000 to 150,000. With this, the dispersion portion 32 derived from one monomer M1 (the siloxane-based compound) having the pendant-type structure exhibits excellent affinity with respect to a silicone oil used as a dispersion medium which is included in the electrophoretic dispersion liquid described below. For this reason, the electrophoretic particles 1 which include the dispersion portion 32 are dispersed with excellent dispersibility in the electrophoretic dispersion liquid without being aggregated and without being adhered to the surface of the electrode. As a result, the electrophoretic device obtained by using the electrophoretic dispersion liquid exhibits the excellent contrast (the property of reflectance).

In addition, the weight-average molecular weight of the dispersion portion 32 may be in a range of 15,000 to 150,000, and is preferably in a range of 16,000 to 100,000, and is further preferably in a range of 18,000 to 50,000. In a case where the weight-average molecular weight is lower than the lower limit value, there is a concern in that depending on the types of monomers M1, it is possible not to contribute the excellent dispersibility with respect to the electrophoretic particle 1 in the electrophoretic dispersion liquid. In addition, in a case where the weight-average molecular weight is greater than the upper limit value, there is a concern in that the productivity thereof is decreased depending on the types of monomers M1.

In addition, the molecular weight distribution of the dispersion portion 32 is preferably equal to or lower than 1.2, is further preferably equal to or lower than 1.1, and is still further preferably equal to or lower than 1.05.

Here, the molecular weight distribution of the dispersion portion 32 represents the ratio (Mw/Mn) of the number average molecular weight (Mn) of the dispersion portion 32 to the weight-average molecular weight (Mw) of the dispersion portion 32, and it can be said that when the molecular weight distribution of the dispersion portion 32 is within the above-described range, the dispersion portions 32 (a portion having the pendant-type structure) which are exposed in the plurality of electrophoretic particles 1 have almost the same length. For this reason, in the electrophoretic dispersion liquid, each of the electrophoretic particles 1 exhibits further uniform dispersion ability. The above-described number average molecular weight (Mn) and the weight-average molecular weight (Mw) can be measured as molecular weight in terms of polystyrene by using, for example, a gel permeation chromatography (GPC) method.

The bonding portion 31 is bonded onto the surface of the base particle 2 in the coated layer 3 provided in the electrophoretic particle 1. With this, the copolymer 39 is bonded to the base particle 2.

The bonding portion 31 is formed by polymerizing two or more (the plurality of) second monomers M2 formed on the surface of the base particle 2, each of which is reacted with a hydroxyl group (the first functional group) so as to be covalently bonded, and has the alkoxysilyl group (the second functional group), and includes two or more (the plurality of) bonding units (constituting units) derived from the monomers M2 which are arranged therein.

As such, it is possible to make further excellent dispersibility of the electrophoretic particles 1 by using the copolymer 39 including the bonding portion 31 which has the plurality of bonding units of which has the second functional group. That is, the copolymer 39 has a plurality of the second functional groups, and the plurality of second functional groups are concentrically present in the bonding portion 31. Further, the bonding portion 31 is obtained by bonding the plurality of bonding units, and thus has a large portion which can be reacted with the base particle 2 as compared with a case where only one bonding unit is present (for example, the coupling agent in the related art). For this reason, it is possible to reliably bond the copolymer 39 onto the surface of the base particle 2 in the bonding portion 31 which is formed by polymerizing the plurality of monomers M2.

In addition, in the embodiment, the hydroxyl group is included as the first functional group on the surface of the base particle 2, and the second functional group included in the monomer M2 is the alkoxysilyl group, as described above. When the hydroxyl group and the alkoxysilyl group are combined with each other, the reaction therebetween exhibits the excellent reactivity, and thus it is possible to reliably bond the copolymer 39 onto the surface of the base particle 2 in the bonding portion 31. That is, the copolymer 39 can reliably have a function as a coupling agent which is bonded onto the surface of the base particle 2.

Such a monomer M2 includes one alkoxysilyl group expressed by the following Formula (II) as the second functional group, and one polymerizable group such that the polymerization is performed by the living radical polymerization.

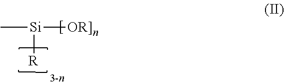

[In the formula, each of R's independently represents an alkyl group having 1 to 4 carbon atoms, and n represents an integer of 1 to 3.]

When the above-described configuration is used as the monomer M2, it is possible to form the bonding portion 31 in which the monomers M2 are polymerized by the living radical polymerization, and the bonding portion 31 which is formed by the living radical polymerization exhibits the excellent reactivity with respect to the hydroxyl group positioned on the surface of the base particle 2.

In addition, examples of one polymerizable group included in the monomers M2 include polymerizable groups having a carbon-carbon double bond such as a vinyl group, a styryl group, and a (meth)acryloyl group.

Examples of such monomers M2 include a vinyl monomer, a vinyl ester monomer, a vinyl amide monomer, a (meth)acrylic monomer, a (meth)acrylic ester monomer, a (meth)acrylamide monomer, and a styryl monomer, each of which includes one alkoxysilyl group expressed by Formula (II), and more specifically include a silane-based monomer containing a silicon atom such as 3-(meth)acryloxypropyl triethoxy (methoxy)silane, vinyl triethoxy (methoxy)silane, 4-vinyl butyl triethoxy (methoxy)silane, 8-vinyl octyltriethoxy (methoxy)silane, 10-methacryloyloxydecyl triethoxy (methoxy)silane, and 10-acryloyloxydecyl triethoxy (methoxy)silane. In addition, these can be used alone or in combination of two or more types thereof.

In addition, in one polymer, the number of bonding units included in the bonding portion 31 may be equal to or greater than 2, but is preferably in a range of 2 to 15, and is further preferably in a range of 3 to 10. When the number of bonding units is larger than the upper limit, the bonding portion 31 has low affinity with respect to the dispersion medium as compared with the dispersion portion 32, and thus in accordance with the type of the monomer M2, the dispersibility of the electrophoretic particles 1 may be deteriorated or the bonding portions 31 may be partially reacted with each other. In addition, when the number of bonding units is smaller than the lower limit, in accordance with the type of the monomer M2, the monomer M2 cannot be sufficiently bonded to the base particle 2, and thus the dispersibility of the electrophoretic particles 1 may be deteriorated.

Further, the number of bonding units included in the bonding portion 31 can be obtained by the analysis by using a general-purpose analysis apparatus such as an NMR spectrum, an IR spectrum, an elemental analysis, and a gel permeation chromatography (GPC). Meanwhile, in the copolymer 39, the bonding portion 31 is a polymer, and thus has a certain molecular weight distribution. Accordingly, the above-described analysis result does not necessarily correspond to all of the polymers 39, but if the number of bonding units which is obtained by using at least one of the above-described methods is in a range of 2 to 10, it is possible to achieve the reactivity between the copolymer 39 and the base particle 2, and the dispersibility and electrophoretic properties (charging properties) of the electrophoretic particle 1.

The copolymer 39 can be obtained by using a manufacturing method described below. For example, in a case where a reversible addition-fragmentation chain transfer polymerization (RAFT) method described below is used, it is possible to obtain a relatively uniform polymer. Accordingly, if 2 mole equivalents to 10 mole equivalents of the monomer M2 is added to, and polymerized with a chain transfer agent, it is possible to set the number of bonding units in the bonding portion 31 to be in the above-described range. In consideration of the aforementioned description, in a case where the additive rate of the monomer M2 is equal to or less than 100%, the polymerization reaction may be performed by setting the additive amount of the monomer M2 to be 2 mole equivalents to 10 mole equivalents.

Meanwhile, in a case where the bonding portion 31 is generated after the dispersion portion 32 is generated, the dispersion portion 32 serves as the chain transfer agent. In this case, for example, the weight-average molecular weight and the number average molecular weight of the polymer which constitute the dispersion portion 32 are obtained by using the GPC method, and then the additive amount of the monomer M2 may be determined based on the obtained result values.

With this, it is possible to reliably exhibit an effect with the configuration such that the electrophoretic particle 1 includes the copolymer 39, and thus the electrophoretic particle 1 has the excellent dispersibility in the electrophoretic dispersion liquid.

In addition, in the electrophoretic particle 1, the weight of the copolymer 39 which is bonded to the base particle 2 in the bonding portion 31 is preferably in a range of 2% by weight to 20% by weight and is further preferably in a range of 3% by weight to 15% by weight in a case where the weight of the base particle 2 is set to be 100% by weight. In a case where the above range is satisfied, it can be said that the copolymers 39 are sufficiently bonded to the base particle 2 in the electrophoretic particle 1, and therefore, it is possible to disperse the electrophoretic particle 1 in the electrophoretic dispersion liquid with the excellent dispersibility.

The electrophoretic particles 1 having the above described configuration are dispersed (suspended) in the dispersion medium (a liquid phase dispersion medium) in the electrophoretic dispersion liquid.

### Dispersion Medium

In the embodiment, a material having a silicone oil as a main component is used as the aforementioned dispersion medium. The silicone oil exhibits the excellent affinity with respect to the dispersion portion 32 which is formed by using the above-described silicone macromonomer as the monomer M1, and thus is used as a dispersion medium.

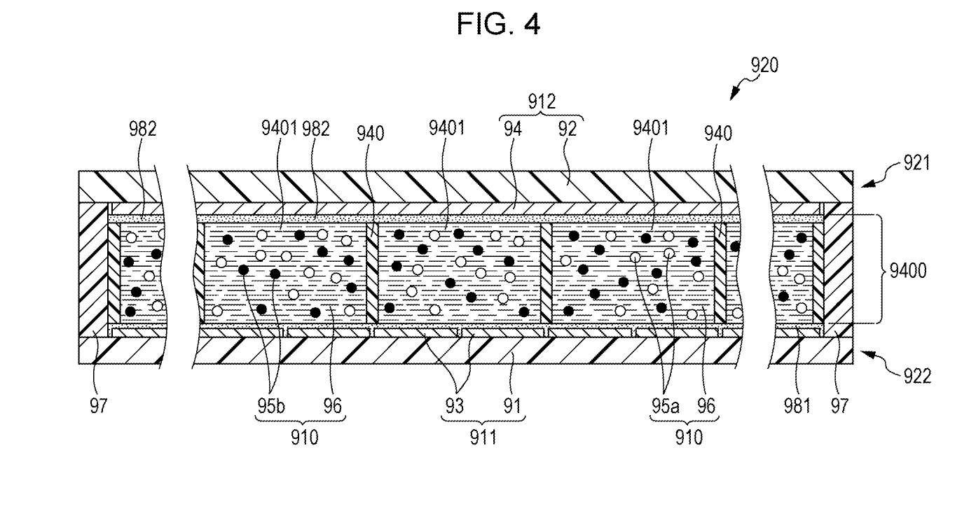

With this, the effect of preventing the electrophoretic particles 1 from being aggregated is enhanced, and thus it is possible to prevent display properties of an electrophoretic display device 920 illustrated in FIG. 4 from being deteriorated over time. In addition, the silicone oil does not have an unsaturated bond and thus is excellent in weather resistance, and has high stability, which is an advantage.

Further, the kinetic viscosity of the silicone oil (the dispersion medium) at a normal temperature (25° C.) is preferably equal to or lower than 5 cs, and is further preferably in a range of 2 cs to 4 cs. Even though the viscosity of the silicone oil (the dispersion medium) is in the above-described range, if the electrophoretic particle 1 includes the dispersion portion 32 formed by the living radical polymerization performed by using the silicone macromonomer as the monomer M1, the electrophoretic particles 1 can be dispersed in the dispersion medium with the excellent dispersibility.

The weight-average molecular weight of the silicone oil is not particularly limited; however, it is preferably in a range of 250 to 700, and is further preferably in a range of 300 to 600. With this, it is possible to disperse the electrophoretic particle 1 in the electrophoretic dispersion liquid with more excellent dispersibility.

In addition, the relative permittivity of the silicone oil is preferably in a range of 1.5 to 3, and is further preferably in a range of 1.7 to 2.8. Such silicone oil is excellent in the dispersibility of the electrophoretic particles 1, and has satisfactory electric insulation. For this reason, the silicone oil contributes to the realization of the electrophoretic display device 920 which has small power consumption and is capable of displaying high contrast. Meanwhile, the value of dielectric constant is a value measured at 50 Hz, and is a value obtained by measuring the dispersion medium in which the amount of moisture is equal to or less than 50 ppm at a temperature of 25° C.

In addition, various additives such as a charge control agent, a lubricant, a stabilizer, and various dyes which are composed of particles such as an electrolyte, a surfactant (anionic or cationic), metal soap, a resin material, a rubber material, oil, varnish, and a compound are added in the dispersion medium, as necessary.

The electrophoretic dispersion liquid in which the above-described electrophoretic particle 1 is dispersed in the dispersion medium can be manufactured as follows, for example.

### Method of Manufacturing Electrophoretic Dispersion Liquid

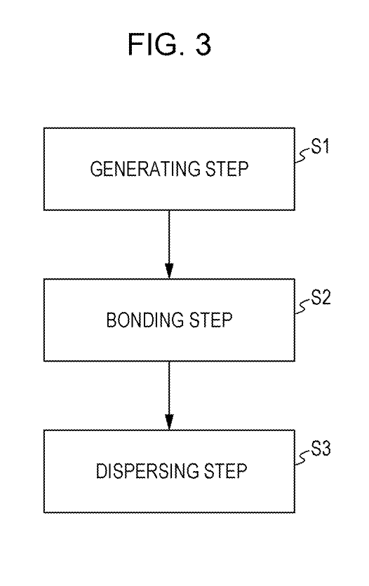

FIG. 3 is a flowchart illustrating a method of manufacturing an electrophoretic dispersion liquid.

The method of manufacturing the above-described electrophoretic dispersion liquid includes a generating step (S1) of generating the plurality of block copolymers 39 (the particle surface treatment agents) in which the dispersion portion 32 and the bonding portion 31 are bonded to each other, a bonding step (S2) of bonding the plurality of block copolymers 39 to the base particle 2 and thus forming the coated layer 3 by the reaction between the first functional group included in the base particle 2 and the second functional group included in the second monomer M2 so as to obtain the electrophoretic particle 1, and a dispersing step (S3) of dispersing the obtained electrophoretic particles 1 in the dispersion medium so as to obtain the electrophoretic dispersion liquid.

Hereinafter, each step will be described in detail.

1. First, the plurality of block copolymers 39 in which the dispersion portion 32 and the bonding portion 31 are bonded to each other are generated (the generation step: S1).

1-1. First, the dispersion portion 32 to which one first monomer M1 is bonded is formed by the living polymerization by performed by using the polymerization initiator.

Examples of the living polymerization method include a living radical polymerization method, a living cationic polymerization method, and a living anionic polymerization method. Among them, the living radical polymerization method is preferably used. When the living radical polymerization method is used, it is possible to simply use a reaction solution and the like generated in the reaction system, and to bond the monomer M1 with satisfactory controllability of the reaction.

In addition, examples of the living radical polymerization method include an atom transfer radical polymerization (ATRP) method, a radical polymerization (NMP) method via nitroxide, a radical polymerization (TERP) method performed by using organotellurium, and a reversible addition-fragmentation chain transfer polymerization (RAFT) method. Among them, the reversible addition-fragmentation chain transfer polymerization (RAFT) method is preferably used. According to the reversible addition-fragmentation chain transfer polymerization (RAFT) method, it is possible to simply bond the monomer M1.

The polymerization initiator (a radical polymerization initiator) is not particularly limited; however, examples thereof include an azo initiator such as 2,2′-azobisisobutyronitrile (AIBN), 2,2′-azobis(4-methoxy-2,4-dimethylvaleronitrile), 2,2′-azobis(2,4-dimethylvaleronitrile), dimethyl 2,2′-azobis(2-methylpropionate), 1,1′-azobis(cyclohexane-1-carbonitrile), 2,2′-azobis[2-(2-imidazolin-2-yl) propane]dihydrochloride, and 2,2′-azobis[2-(2-imidazolin-2-yl) propane], and persulfate such as potassium persulfate, and ammonium persulfate.

In addition, in the case where the reversible addition-fragmentation chain transfer polymerization (RAFT) method is used, a chain transfer agent (a RAFT agent) is used other than the polymerization initiator. The chain transfer agent is not particularly limited; however, examples thereof include a sulfur compound having a functional group such as a dithioester group, a trithiocarbamate group, a xanthate group, and a dithiocarbamate group.

Specifically, examples of the chain transfer agent include a compound expressed by the following Formulae (1) to (7), and these may be used alone or in combination of two or more types thereof. These compounds are relatively easily available, and can easily perform control of the reaction, and thus are preferably used.

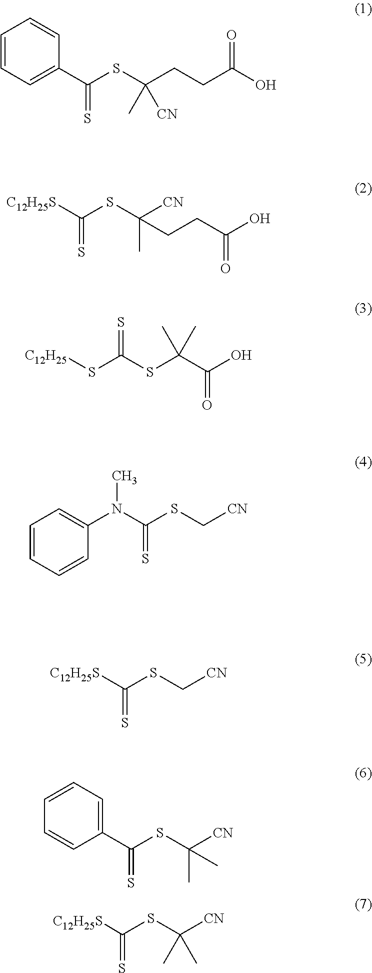

Among these, the chain transfer agent is preferably 2-cyano-2-propyl benzo dithioate expressed by the above-described Formula (6). With this, it is possible to more easily control the reaction.

Further, in a case where the reversible addition-fragmentation chain transfer polymerization (RAFT) method is used, the ratio of the monomer M1, the polymerization initiator, and the chain transfer agent is appropriately determined in consideration the reactivity of the dispersion portion 32 to be formed and compounds such as the monomer M1, and the molar ratio between the monomer M1, the polymerization initiator, and the chain transfer agent is preferably monomer M1:polymerization initiator:chain transfer agent=3 to 1:5 to 0.25:1. With this, it is possible to reliably obtain the dispersion portion 32 which is obtained by bonding one monomer M1.

In addition, examples of the solvent for preparing the solution which bonds the monomer M1 by the living radical polymerization include water, alcohol such as methanol, ethanol, and butanol, a hydrocarbon such as hexane, octane, benzene, toluene, and xylene, an ether such as diethyl ether and tetrahydrofuran, an ester such as ethyl acetate and butyl acetate, a halogenated aromatic hydrocarbon such as chlorobenzene and o-dichlorobenzene. These may be used alone or as a mixed solvent.

In addition, it is preferable that the solution (a reaction solution) is subjected to a deoxygenation treatment before starting the polymerization reaction. Examples of the deoxygenation treatment include substitution after the vacuum degassing due to an inert gas such as an argon gas and a nitrogen gas, and a purge treatment.

Further, at the time of bonding reaction of the monomer M1, it is possible to further rapidly and reliably perform the bonding reaction of the monomers by heating the solution up to a certain temperature.

The heating temperature is slightly different depending on the type of the monomer M1, and thus is not particularly limited; the heating temperature is preferably in a range of approximately 30° C. to 100° C. In addition, the heating time (reaction time) is preferably in a range of 3 hours to 48 hours in a case where the heating temperature is set to be in the above-described range.

Meanwhile, in a case where the reversible addition-fragmentation chain transfer polymerization (RAFT) method is used, a fragment of the chain transfer agent which is used as one terminal (a tip end portion) of the dispersion portion 32 remains. Then, the dispersion portion 32 having the aforementioned fragment acts as the chain transfer agent in the reaction of bonding the dispersion portion 32 and the bonding portion 31 in the following step 1-2.

1-2. Next, the bonding portion 31 in which the second monomers M2 each of which has the second functional group having the reactivity with the first functional group included in the base particle 2 are polymerized is formed so as to be bonded to the dispersion portion 32.

With this, the copolymer 39 configured to have a block copolymer in which the dispersion portion 32 and the bonding portion 31 are bonded to each other is generated.

In addition, in the step 1-2, before forming the bonding portion 31 which uses the monomer M2, impurities such as the solvent and the polymerization initiator which are used in the previous step 1-1 are removed as necessary such that the dispersion portion 32 may be subjected to a purification treatment (a removing treatment) for isolating and purifying. With this, the obtained copolymers 39 become more uniform and are highly purified. The aforementioned purification treatment is not particularly limited, and for example, examples thereof include a column chromatography method, a recrystallization method, and a re-precipitation method. These may be used alone or in combination of two or more types thereof.

In addition, as described above, when the reversible addition-fragmentation chain transfer polymerization (RAFT) method is used, the fragment of the chain transfer agent which is used as one terminal of the dispersion portion 32 remains. For this reason, the bonding portion 31 having the above-described configuration is formed in such a manner that a solution containing the dispersion portion 32, the monomer M2, and the polymerization initiator which are obtained after the previous step 1-1 is prepared and the living polymerization is performed again in the aforementioned solution.

Note that, at this time, the ratio of the monomer M2 to the dispersion portion 32 is determined in order to bond the bonding portion 31 to the dispersion portion 32, and the mole ratio of the monomer M2 to the dispersion portion 32 is preferably in a range of 500 to 5:1. With this, it is possible to generate the copolymer 39 which includes the bonding portion 31 and the dispersion portion 32, and is obtained by bonding one monomer M1 to the bonding portion 31, with excellent generation rate.

In addition, as the solvent used in the current step, the same solvent as that used in the previous step 1-1 can be used, and it is possible to set the condition at the time of polymerizing the monomers M2 in the solution to be the same as the condition at the time of polymerizing the monomers M1 in the solution in the previous step 1-1.

In addition, after the current step 1-2, impurities such as a solvent used in the current step 1-2 are removed, and the copolymer 39 is subjected to a purification treatment (a removing treatment) for isolating and purifying. With this, the copolymer 39 can be smoothly bonded to the base particle 2 in the next step 2; however, the description thereof will be described below in detail. The aforementioned purification treatment is not particularly limited, and for example, examples thereof include a column chromatography method, a recrystallization method, and a re-precipitation method. These may be used alone or in combination of two or more types thereof.

2. Next, the coated layer 3 is formed in such a manner that the first functional group included in the base particle 2 and the plurality of second functional groups in the bonding portion 31 are reacted with each other and then are chemically bonded to each other such that the plurality of block copolymers 39 (the particle surface treatment agent) are bonded to the surface of the base particle 2 (the bonding step; S2).

With this, it is possible to obtain the electrophoretic particle 1 in which at least a portion of the base particle 2 is coated with the coated layer 3.

Examples of such processes include a dry method and a wet method described below.

### Dry Method

In the dry method, first, a solution is prepared by mixing the copolymer 39 and the base particle 2 in an appropriate solvent. Note that, in the solution, in order to facilitate hydrolysis of the alkoxysilyl group (the second functional group) included in the copolymer 39, a little amount of water, an acid, and a base may be added if necessary. Further, heating, light irradiation, or the like may be performed if necessary.

In this case, with respect to the volume of the base particle 2, the volume of the solvent is preferably in a range of 1% by volume to 20% by volume, and is further preferably in a range of 5% by volume to 10% by volume. With this, it is possible to increase the number of the case where the copolymer 39 comes in contact with the base particle 2, and thus it is possible to more reliably bond the bonding portion 31 to the surface of the base particle 2.

Next, the solvent is removed after the copolymer 39 is adsorbed on the surface of the base particle 2 with high efficiency by performing the dispersion by ultrasonic irradiation or the stirring by using a ball mill and a bead mill.

Then, the powders obtained by removing the solvent is heated under the condition “at the temperature preferably in a range of 100° C. to 200° C. for one hour or more” so as to decompose the alkoxysilyl group (the second functional group), and then the decomposed alkoxysilyl group and the hydroxyl group (first functional group) exposed on the surface of the base particle 2 are chemically bonded to each other, thereby obtaining the electrophoretic particle 1.

Subsequently, the remaining polymers 39 which are adsorbed onto the surface of the base particle 2 is removed by being washed several times in the solvent again by using a centrifugal separator without forming the aforementioned chemical bond.

With such steps described above, it is possible to obtain the purified electrophoretic particle 1.

### Wet Method

In the wet method, first, a solution is prepared by mixing the copolymer 39 and the base particle 2 in an appropriate solvent. Note that, in the solution, in order to facilitate hydrolysis of the alkoxysilyl group (the second functional group) included in the copolymer 39, a little amount of water, an acid, and a base may be added if necessary. Further, heating, light irradiation, or the like may be performed if necessary.

In this case, with respect to the volume of the base particle 2, the volume of the solvent is preferably in a range of 1% by volume to 20% by volume, and is further preferably in a range of 5% by volume to 10% by volume. With this, it is possible to increase the number of the case where the copolymer 39 comes in contact with the base particle 2, and thus it is possible to more reliably bond the bonding portion 31 to the surface of the base particle 2.

Next, after the copolymer 39 is adsorbed on the surface of the base particle 2 with high efficiency by performing the dispersion by ultrasonic irradiation or the stirring by using a ball mill and a bead mill, the solution is heated under the condition “at the temperature preferably in a range of 100° C. to 200° C. for one hour or more” so as to decompose the alkoxysilyl group (the second functional group), and then the decomposed alkoxysilyl and the hydroxyl group (first functional group) exposed on the surface of the base particle 2 are chemically bonded to each other, thereby obtaining the electrophoretic particle 1.

Subsequently, the remaining polymers 39 which are adsorbed onto the surface of the base particle 2 is removed by being washed several times in the solvent again by using a centrifugal separator without forming the aforementioned chemical bond.

With such steps described above, it is possible to obtain the purified electrophoretic particle 1.

Note that, depending on the types of the monomers M1 for forming the copolymer 39, the electrophoretic particle 1 is not dispersed in the dispersion solvent in some cases when being dried. In such a case, it is preferable that a solvent displacement in which a reactive solvent is gradually substituted to the dispersion solvent (without being dried) be used at the time of washing operation.

In addition, as the solvent used in the current step, the same solvent as that used in the previous step 1-1 can be used, and the silicone oil which is exemplified as the dispersion liquid contained in the electrophoretic dispersion liquid can also be used.

3. Next, the electrophoretic dispersion liquid is obtained by dispersing the obtained electrophoretic particle 1 in the dispersion medium (dispersing step: S3).

In the embodiment, a material having the aforementioned silicone oil as a main component is used as the aforementioned dispersion medium.

In addition, the method of dispersing the electrophoretic particle 1 in the dispersion medium is not particularly limited; however, examples thereof include a paint shaker method, a ball mill method, a media mill method, an ultrasonic dispersion method, and a stirring dispersion method. These may be used alone or in combination of two or more types thereof.

With such steps described above, it is possible to obtain the electrophoretic dispersion liquid in which the positive and negative electrophoretic particles are reliably suppressed or prevented from being aggregated with each other and from being adhered to the electrode surface, and as a result, the problem in that degradation of the contrast (the property of reflectance) is caused is solved.

Note that, in the embodiment, in the previous step 1, a case where the block copolymer 39 is generated by bonding the bonding portion 31 to the dispersion portion 32 after forming the dispersion portion 32 is described; however, without limiting to this case, the block copolymer 39 may be generated by bonding the dispersion portion 32 to the bonding portion 31 after forming the bonding portion 31.

### Electrophoretic Display Device

Next, the electrophoretic display device (the electrophoretic device of the invention) to which the electrophoretic sheet of the embodiment of the invention is applied will be described below.

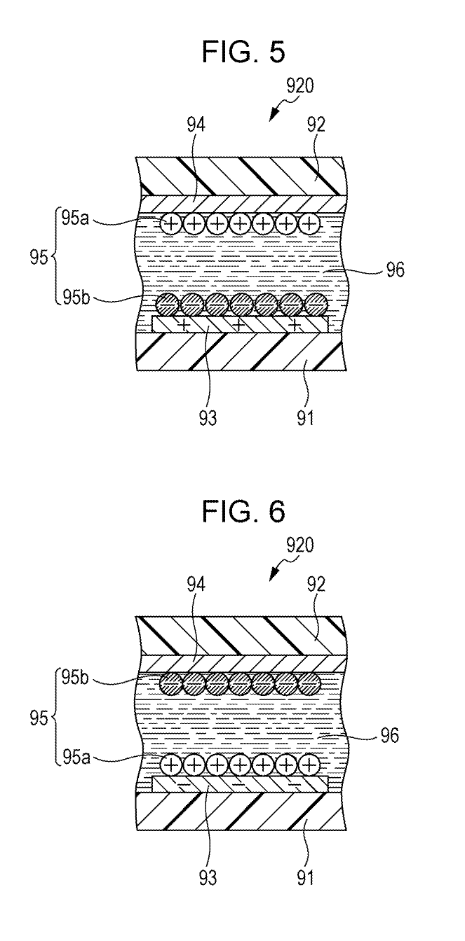

FIG. 4 is a diagram for schematically illustrating a longitudinal cross section of the electrophoretic display device of the embodiment, and FIGS. 5 and 6 are schematic diagrams illustrating an operating principle of the electrophoretic display device illustrated in FIG. 4. Note that, in the following description, for the convenience of explanation, the upper side is described as “up” and the lower side is described as “low” in FIGS. 4 to 6.

The electrophoretic display device 920 illustrated in FIG. 4 includes an electrophoresis display sheet (front plane) 921, a circuit board (backplane) 922, an adhesive layer 981 which bonds the electrophoresis display sheet 921 and the circuit board 922, and a sealing portion 97 which air-tightly seals a gap between the electrophoresis display sheet 921 and the circuit board 922.

The electrophoresis display sheet (the electrophoretic sheet of the invention) 921 includes a substrate 912 which is provided with a flat base portion 92 and a second electrode 94 on the lower surface of the base portion 92, and a display layer 9400 which is provided on the lower surface (one surface) side of the substrate 912, and is formed of a partition wall 940 formed in a matrix shape and an electrophoretic dispersion liquid 910.

On the other hand, a circuit board 922 includes a counter substrate 911 which is provided with a flat base portion 91 and a plurality of first electrodes 93 on the upper surface of the base portion 91, a circuit (not shown) which is provided on the counter substrate 911 (the base portion 91), and includes a switching element such as a TFT, and a driving IC (not shown) for driving the switching element.

Hereinafter, the configuration of each portion will be sequentially described.

Each of the base portion 91 and the base portion 92 is formed of a sheet-like (flat) member, and has a function of supporting and protecting each member disposed between the base portion 91 and the base portion 92.

Each of the base portions 91 and 92 may be formed of a flexible material or a hard material; however, the flexible material is preferably used. With the base portions 91 and 92 having flexibility, it is possible to obtain the electrophoretic display device 920 having flexibility, that is, the electrophoretic display device 920 which is useful to construct the electronic paper.

In addition, in a case where each of the base portions (base material layers) 91 and 92 has the flexibility, the base portions 91 and 92 are preferably formed of a resin material.

The average thickness of each of the base portions 91 and 92 is appropriately set in accordance with a constituting material and an application. In addition, the average thickness thereof is not particularly limited, but is preferably in a range of 20 μm to 500 μm, and is further preferably in a range of 25 μm to 250 μm.

Each of the first electrode 93 and the second electrode 94 which are formed into a layer shape (a film shape) is provided on the surface of the base portions 91 and 92 on the partition wall 940 side, that is, on the upper surface of the base portion 91 and the lower surface of the base portion 92.

If the voltage is applied across the first electrode 93 and the second electrode 94, an electric field is generated therebetween, and thus the generated electric field acts on an electrophoretic particle 95.

In the embodiment, the second electrode 94 is set to be a common electrode, the first electrode 93 is set to be an individual electrode (a pixel electrode which is connected to the switching element) which is divided in a matrix shape, and a portion in which the second electrode 94 and one first electrode 93 are overlapped with each other constitutes one pixel.

The constituting material of each of the electrodes 93 and 94 is not particularly limited as long as the material substantially has conductivity.

The average thickness of such electrodes 93 and 94 is appropriately set in accordance with a constituting material and an application. In addition, the average thickness thereof is not particularly limited, but is preferably in a range of 0.05 μm to 10 μm, and is further preferably in a range of 0.05 μm to 5 μm.

Further, in each of the base portions 91 and 92, and each of the electrodes 93 and 94, each of the base portion and the electrode (in the embodiment, the base portion 92 and the second electrode 94) which are disposed on the display surface side has light transmittance, that is, the base portion and the electrode are substantially transparent (colorless and transparent, colored transparent, or semi-transparent).

In the electrophoresis display sheet 921, the display layer 9400 is provided in a state of coming in contact with the lower surface of the second electrode 94.

The display layer 9400 is accommodated (sealed) in a plurality of pixel spaces 9401 in which the electrophoretic dispersion liquid (the electrophoretic dispersion liquid of the embodiment of the invention described above) 910 is defined by the partition wall 940.

The partition wall 940 is formed between the counter substrate 911 and the substrate 912 so as to divide the pixel spaces in a matrix shape.

Examples of the constituting material of the partition wall 940 include various types of resin materials such as a thermoplastic resin such as an acrylic resin, a urethane resin, and an olefin resin, a thermosetting resin such as an epoxy resin, a melamine resin, and a phenolic resin. These may be used alone or in combination of two or more types thereof.

In the embodiment, the partition wall 940 is bonded to the second electrode 94 via an adhesive layer 982, and thus the partition wall 940 is fixed onto the substrate 912.

In the embodiment, the electrophoretic dispersion liquid 910 which is accommodated in the pixel space 9401 is formed by dispersing (suspending) two types particles (at least one type of the electrophoretic particles 1) which are coloring particles 95b and white particles 95a in the dispersion medium 96, and the electrophoretic dispersion liquid of the embodiment of the invention described above is applied thereto.

In such an electrophoretic display device 920, if the voltage is applied across the first electrode 93 and the second electrode 94, an electric field is generated therebetween, and thus the coloring particles 95b and the white particles 95a (the electrophoretic particle 1) are electrophoretically moved toward any one of the first electrode 93 and the second electrode 94.

In the embodiment, the positively charged white particles 95a and the negatively charged coloring particles (black particles) 95b are used. That is, as the white particle 95a, the electrophoretic particle 1 in which the base particle 2 is positively (plus) charged is used, and as the coloring particle 95b, the electrophoretic particle 1 in which the base particle 2 is negatively (minus) charged is used.

In a case where the aforementioned electrophoretic particles 1 are used, when the first electrode 93 is set to be a negative potential, as illustrated in FIG. 6, the coloring particles 95b are moved to the second electrode 94 side so as to be collected in the second electrode 94. On the other hand, the white particles 95a are moved to the first electrode 93 side so as to be collected in the first electrode 93. For this reason, when the electrophoretic display device 920 is viewed from above (display surface side), the color of coloring particles 95b can be seen, that is, a black color can be seen.

In contrast, if the first electrode 93 is set to be a positive potential, as illustrated in FIG. 5, the coloring particles 95b are move to the first electrode 93 side so as to be collected in the first electrode 93. On the other hand, the white particles 95a are moved to the second electrode 94 side so as to be collected in the second electrode 94. For this reason, when the electrophoretic display device 920 is viewed from the above (the display surface side), the color of the white particles 95a can be seen, that is, a white color can be seen.

With such a configuration, the amount of charging the white particles 95a and the coloring particles 95b (the electrophoretic particle 1), the polarity of each of the electrodes 93 and 94, and the potential difference between electrodes 93 and 94 are appropriately set, and thus in accordance with a combination of colors of the white particles 95a and the coloring particles 95b, or the number of particles collecting in the electrodes 93 and 94, desired information (images) is displayed on the display surface of the electrophoretic display device 920.

In addition, a specific gravity of the electrophoretic particle 1 is preferably set to be substantially the same as a specific gravity of the dispersion medium 96. With this, the electrophoretic particle 1 can stay at a certain position for a long period of time in the dispersion medium 96 even after stopping the application of a voltage across the electrodes 93 and 94. That is, the information displayed on the electrophoretic display device 920 can be held for a long period of time.

Note that, the average particle size of the electrophoretic particle 1 is preferably in a range of 0.1 μm to 10 μm, and is further preferably in a range of 0.1 μm to 7.5 μm. When the average particle size of the electrophoretic particle 1 is set to be in the above-described range, it is possible to reliably prevent the electrophoretic particles 1 from being aggregated each other, and from being precipitated in the dispersion medium 96. As a result, it is possible to preferably prevent the display quality of the electrophoretic display device 920 from being deteriorated.

In the embodiment, the electrophoresis display sheet 921 and the circuit board 922 are bonded to each other via the adhesive layer 981. With this, the electrophoresis display sheet 921 and the circuit board 922 can be more reliably fixed to each other.

The average thickness of the adhesive layer 981 is not particularly limited, but is preferably in a range of 1 μm to 30 μm, and is further preferably in a range of 5 μm to 20 μm.

The sealing portion 97 is provided between the base portion 91 and the base portion 92, and specifically, the sealing portion 97 is provided along the edge portion of the base portion 91 and the base portion 92. The electrodes 93 and 94, the display layer 9400, and the adhesive layer 981 are air-tightly sealed by the sealing portion 97. With this, it is possible to prevent water from entering the electrophoretic display device 920, and more reliably prevent the display performance of the electrophoretic display device 920 from being deteriorated.

As the constituting material of the sealing portion 97, the same materials as those which are exemplified as the constituting material of the aforementioned partition wall 940 can be used.

### Electronic Apparatus

Next, the electronic apparatus of the embodiment of the invention will be described.

The electronic apparatus of the embodiment of the invention is provided with the above-described electrophoretic display device 920.

### Electronic Paper

First, an embodiment of a case where the electronic apparatus of the embodiment of the invention is applied to an electronic paper will be described.

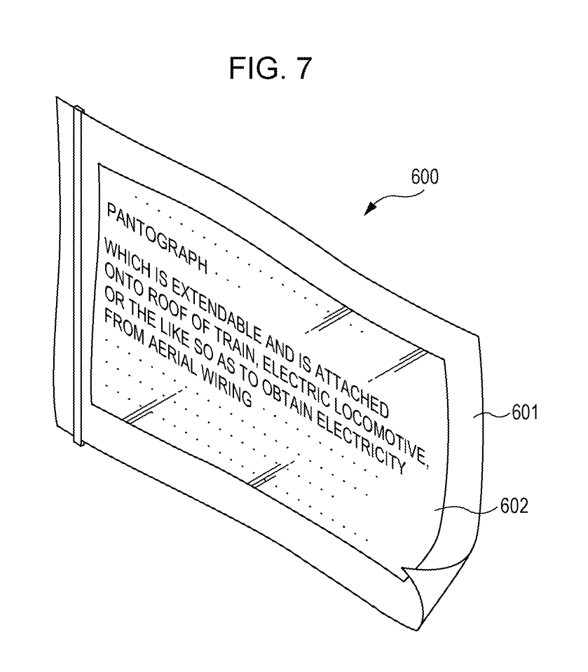

FIG. 7 is a perspective view illustrating an embodiment in a case where the electronic apparatus of the invention is applied to the electronic paper.

The electronic paper 600 illustrated in FIG. 7 is provided with a main body 601, which is formed of a rewritable sheet having the same texture and flexibility as those of paper, and a display unit 602.

In such an electronic paper 600, the display unit 602 is formed of the above-described electrophoretic display device 920.

### Display

Next, an embodiment in a case where the electronic apparatus of the embodiment of the invention is applied to the display will be described below.

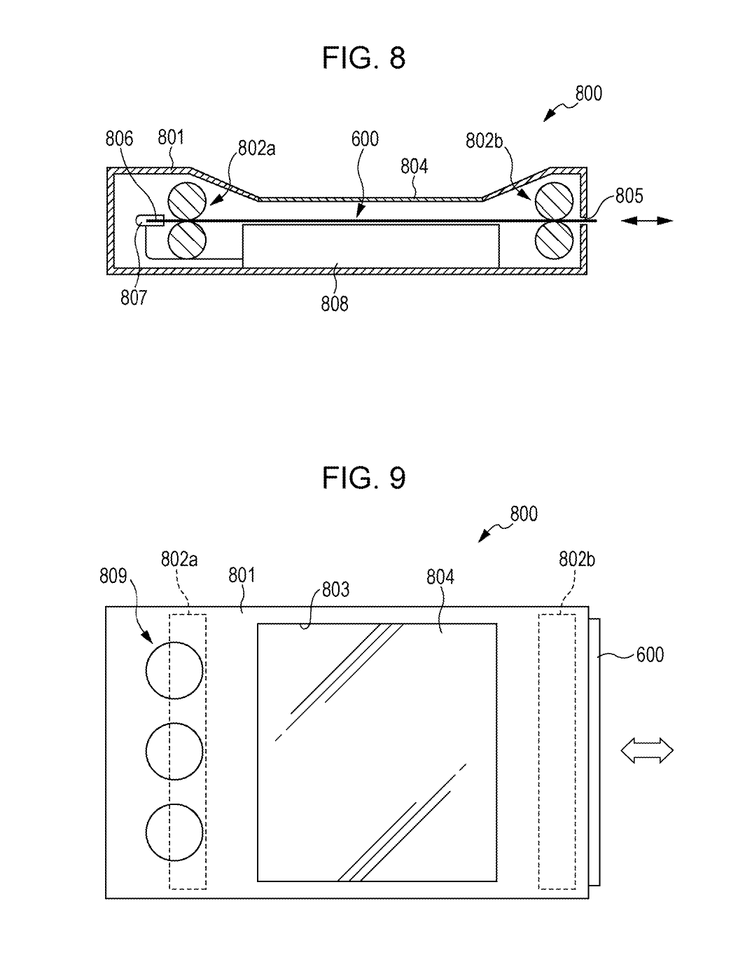

FIGS. 8 and 9 are diagrams illustrating an embodiment in a case where the electronic apparatus of the embodiment of the invention is applied to a display. FIG. 8 is a sectional view and FIG. 9 is a plan view.

A display (a display device) 800 illustrated in FIGS. 8 and 9 is provided with a main body portion 801 and the electronic paper 600 which is detachably provided with respect to the main body portion 801.

In the main body portion 801, an insertion port 805 which can be inserted into the electronic paper 600 is formed in a side portion (the right side in FIG. 8), and two pairs of transport rollers 802a and 802b are provided thereinside. When the electronic paper 600 is inserted into the main body portion 801 via an insertion port 805, the electronic paper 600 is installed on the main body portion 801 in a state being interposed between the pair of transport rollers 802a and 802b.

In addition, a rectangular hole portion 803 is formed on the display surface side (the front side of the paper in FIG. 9) of the main body portion 801, and a transparent glass plate 804 is fitted into the hole portion 803. With this, it is possible to visually recognize the electronic paper 600 in a state of being installed in the main body portion 801 from the outside of the main body portion 801. That is, in the display 800, a display surface is formed in such a way that the electronic paper 600 in the state of being installed in the main body portion 801 is visually recognized in the transparent glass plate 804.

In addition, a terminal portion 806 is provided at a tip end portion (the left side in FIG. 8) of the electronic paper 600 in an insertion direction, and a socket 807 which is connected to the terminal portion 806 is provided in the main body portion 801 in the state where the electronic paper 600 is installed in the main body portion 801. A controller 808 and an operation unit 809 are electrically connected to the socket 807.

In such a display 800, the electronic paper 600 is detachably installed in the main body portion 801, and can be portably used in a state of being detached from the main body portion 801.

In addition, in such a display 800, the electronic paper 600 is formed of the above-described electrophoretic display device 920.

Note that, the application of the electronic apparatus of the embodiment of the invention is not limited to the above description; for example, application examples thereof include a television, a view finder type or a monitor direct view type video tape recorder, a car navigation device, a pager, an electronic organizer, an electronic calculator, an electronic newspaper, a word processor, a personal computer, a workstation, a television telephone, a POS terminal, and a device provided with a touch panel, and it is possible to apply the electrophoretic display device 920 to the display portion of the aforementioned various electronic apparatuses.

As described above, the electrophoretic particle, the electrophoretic dispersion liquid, the electrophoretic sheet, the electrophoretic device, and the electronic apparatus of the embodiment of the invention are described with reference to embodiments illustrated in the drawings; however, the invention is not limited thereto, and the configuration of each portion can be replaced with any other configuration having the same function. In addition, other components may be added to the invention.

### EXAMPLES

Next, specific examples will be described below. Manufacturing of electrophoretic particle, preparing of electrophoretic dispersion liquid, and evaluation of electrophoretic dispersion liquid.

### Example 1A

### 1. Synthesizing of Block Copolymer by Polymerization

70 g of a terminal methacrylic group of a silicone macromonomer having the weight-average molecular weight of 16,000, 1.0 g of 2-cyano-2-propyl benzo dithioate, and 400 mg of azobisisobutyronitrile were added into a flask, the mixture was substituted with nitrogen, 100 mL of ethyl acetate was added into the mixture, thereafter, 5.0 g of 3-methacryloxypropyl triethoxy silane (“KBE-503”, manufactured by Shin-Etsu Silicones) was added to the mixture, and then the mixture was heated while being stirred again for four hours at 75° C. so as to carry out the polymerization. The reaction is finished by cooling the resultant up to room temperature, and then the solvent was removed so as to obtain a block copolymer in which the dispersion portion and the bonding portion are bonded to each other.

In addition, the number of a first unit and a second unit in the obtained block copolymer can be calculated by using NMR (“Model No. 500NB”, manufactured by Varian, Inc), and the number of the first units was one, and the number of the second units was two.

### 2. Adjustment of Electrophoretic Dispersion Liquid

An electrophoretic particle was obtained in such a manner that, in the flask, 10 g of block copolymer (raw material) obtained above and 60 g of titania particle (“CR50”, manufactured by Ishihara Sangyo Kaisha, Ltd.) were added so as to prepare a mixture, after that, the mixture was subjected to an ultrasonic treatment for one hour, and the mixture was heated and stirred for four hours at 150° C. such that the block copolymer was bonded to the particle. A white electrophoretic dispersion liquid was obtained by removing unreacted block copolymer from the reacted solution, and then adding the obtained electrophoretic particle to “KF-96-2 cs” manufactured by Shin-Etsu Chemical Co., Ltd.

In addition, except that 60 g of titanium black particle (“13MT”, manufactured by Mitsubishi Materials Co., Ltd.) was used instead of the titania particle, a black electrophoretic dispersion liquid was obtained by using the same method as that in the above description.

### Examples 2A to 5A, and Comparative Example 1A

The white and black electrophoretic dispersion liquids were obtained by using the same method as that in Example 1A, except that the number of the second units was changed as indicated in Tables 1 and 2 by appropriately preparing the additive amount of 3-methacryloxypropyl triethoxy silane added into the system at the time of synthesizing the block copolymer.

### Examples 1B and 2B, and Comparative Examples 1B and 2B

The white and black electrophoretic dispersion liquids were obtained by using the same method as that in Example 1A, except that a terminal hydroxyl group of a silicone having the weight-average molecular weight as indicated in Tables 4 and 5 instead of the terminal methacrylic group of a silicone having the weight-average molecular weight of 16,000 added to the system at the time of synthesizing the block copolymer.

### 3. Evaluation of Electrophoretic Dispersion Liquid

### 3-1. Confirming of Number of Second Units in Block Copolymer

3-1a. Evaluation of Particle Aggregation and Electrode Adhesiveness

Regarding the electrophoretic dispersion liquids in Examples 1A to 5A, and Comparative Example 1A, particle aggregation and electrode adhesiveness were evaluated as follows.

### Evaluation of Particle Aggregation

In other words, the black electrophoretic dispersion liquid and the white electrophoretic dispersion liquid in Examples 1A to 5A, and Comparative Example 1A were observed at 200-fold magnification by using a microscope.

As a result, if the aggregation of the electrophoretic particle was not recognized in the electrophoretic dispersion liquid, and the electrophoretic particles were almost evenly distributed in the electrophoretic dispersion liquid without irregularity, the evaluation was determined as A, if the aggregation of the electrophoretic particle was slightly recognized, but the electrophoretic particles were almost evenly distributed in the electrophoretic dispersion liquid and the irregularity was almost not found, the evaluation was determined as B, and if the aggregation of the electrophoretic particle was apparently recognized, and the electrophoretic particles are maldistributed in the electrophoretic dispersion liquid with irregularity, the evaluation was determined as C.

### Evaluation of Electrode Adhesiveness

Two pieces of ITO deposition glass were disposed with a gap of 50 μm therebetween, then a voltage of 15 V was applied across electrodes in a state where the white electrophoretic dispersion liquid and the black electrophoretic dispersion liquid of Example and Comparative Example were added dropwise in the gap, and at that time, the existence of electrophoretic particles adhered to the electrode surface was observed at 200-fold magnification by using a microscope.

As a result, if the electrophoretic particles were not adhered onto the electrode surface in the electrophoretic dispersion liquid, the evaluation was determined as A, if the electrophoretic particles were slightly adhered onto the electrode surface in the electrophoretic dispersion liquid, and the adhesion of the particles on the electrode surface was eliminated due to the application of voltage, the evaluation was determined as B, and if the electrophoretic particles were apparently adhered onto the electrode surface in the electrophoretic dispersion liquid, and the adhesion of the particles on the electrode surface was not eliminated due to the application of voltage, the evaluation was determined as C.

The evaluation results are indicated in Tables 1 and 2.

TABLE 1

| | | Block copolymer | | | | | |
|---|---|---|---|---|---|---|---|
| | Particle | | Number | | Number of | Evaluation | |
| | (white | | of first | Second | second | Particle | Electrode |
| | particle) | First monomer | units | monomer | units | aggregation | adhesiveness |
| Example 1A | CR50 | 16k siloxane MA | 1 | KBE-503 | 2 | A | B |
| Example 2A | CR50 | 16k siloxane MA | 1 | KBE-503 | 5 | A | A |
| Example 3A | CR50 | 17k siloxane MA | 1 | KBE-503 | 10 | A | B |
| Example 4A | CR50 | 18k siloxane MA | 1 | KBE-503 | 15 | A | B |
| Example 5A | CR50 | 19k siloxane MA | 1 | KBE-503 | 20 | B | B |
| Comparative | CR50 | 16k siloxane MA | 1 | KBE-503 | 1 | C | C |
| Example 1A | | | | | | | |

TABLE 2

| | | Block copolymer | | | | | |
|---|---|---|---|---|---|---|---|
| | Particle | | Number | | Number of | Evaluation | |
| | (black | | of first | Second | second | Particle | Electrode |
| | particle) | First monomer | units | monomer | units | aggregation | adhesiveness |
| Example 1A | 13MT | 16k siloxane MA | 1 | KBE-503 | 2 | A | B |
| Example 2A | 13MT | 16k siloxane MA | 1 | KBE-503 | 5 | A | A |
| Example 3A | 13MT | 17k siloxane MA | 1 | KBE-503 | 10 | A | B |
| Example 4A | 13MT | 18k siloxane MA | 1 | KBE-503 | 15 | A | B |
| Example 5A | 13MT | 19k siloxane MA | 1 | KBE-503 | 20 | B | B |
| Comparative | 13MT | 16k siloxane MA | 1 | KBE-503 | 1 | C | C |
| Example 1A | | | | | | | |

As apparently indicated in Tables 1 and 2, in the electrophoretic dispersion liquids of the respective Examples, the aggregation of the electrophoretic particles in the black electrophoretic dispersion liquid and white electrophoretic dispersion liquid, and the adhesion of the electrophoretic particles to the electrode were appropriately suppressed, and thus it was found that the electrophoretic particles in the electrophoretic dispersion liquid exhibited the excellent dispersibility and the electrophoretic properties.

In contrast, in the electrophoretic dispersion liquid in Comparative Example 1A, it was recognized that since the number of the second units is one, a sufficient amount of the block copolymer cannot be bonded with respect to the particle, and thus the electrophoretic particles are aggregated with each other in the electrophoretic dispersion liquid, and the electrophoretic particles are adhered to the electrode. As a result, it was found that the electrophoretic particles in the electrophoretic dispersion liquid were not excellent in the dispersibility and the phoretic properties.

3-1b. Evaluation of Display Properties

In addition, regarding the electrophoretic dispersion liquid in Examples 1A to 5A and Comparative Example 1A, the evaluation of display properties was performed as follows.

### Evaluation of Display Properties

First, regarding the electrophoretic dispersion liquid containing the white particles in Examples 1A to 5A and Comparative Example 1A, and the electrophoretic dispersion liquid containing the black particles in Examples 1A to 5A and Comparative Example 1A, the electrophoretic dispersion liquid containing white particle the black particle the was prepared by combining the white particle and the black particle in Examples and Comparative Examples such that the volume ration of the white electrophoretic dispersion liquid to the black electrophoretic dispersion liquid in the mixture is 10:1.

Then, a transparent electrode cell having the thickness of 50 μm was injected into the prepared electrophoretic dispersion liquid, and then white reflectance at the time of white display, and black reflectance at the time of black display were measured so as to calculate contrasts thereof.

The evaluation results are indicated in Table 3.

TABLE 3

| White electrophoretic | Black electrophoretic | |
|---|---|---|
| dispersion liquid | dispersion liquid | |
| (Content of block | (Content of block | White reflectance/black |
| copolymer) | copolymer) | reflectance |
| Example 1A | Example 1A | 45/3.7 |
| Example 2A | Example 2A | 47/3.5 |
| Example 3A | Example 3A | 48/3.2 |
| Example 4A | Example 4A | 48/3.1 |
| Example 5A | Example 5A | 49/2.9 |
| Comparative | Comparative | 34/5.1 |
| Example 1A | Example 1A | |

As apparent from Table 3, in electrophoretic dispersion liquid obtained by combining the white particle and the black particle in the respective Examples, the electrophoretic particle exhibited the excellent contrast, that is, display properties in the electrophoretic dispersion liquid without the aggregation generated between the white particle and the black particle.

In contrast, in the electrophoretic dispersion liquid obtained by combining the white particle and the black particle in Comparative Example 1A, since the number of the second units is one, a sufficient amount of the block copolymer cannot be bonded with respect to the particle, and thus the aggregation is generated between the white particle and the black particle. As a result, it was found that the contrast, that is, the display properties are deteriorated.

### 3-2. Confirming of Molecular Weight of First Units in Block Copolymer

3-2a. Evaluation of Particle Aggregation and Electrode Adhesiveness

Regarding the electrophoretic dispersion liquids in Examples 1B and 2B, and Comparative Examples 1B and 2B, particle aggregation and electrode adhesiveness were evaluated as follows.

### Evaluation of Particle Aggregation

In other words, the white electrophoretic dispersion liquid and the black electrophoretic dispersion liquid in Examples 1B and 2B, and Comparative Examples 1B and 2B were observed at 200-fold magnification by using a microscope.

As a result, if the aggregation of the electrophoretic particle was not recognized in the electrophoretic dispersion liquid, and the electrophoretic particles were almost evenly distributed in the electrophoretic dispersion liquid without irregularity, the evaluation was determined as A, if the aggregation of the electrophoretic particle was slightly recognized, but the electrophoretic particles were almost evenly distributed in the electrophoretic dispersion liquid and the irregularity was almost not found, the evaluation was determined as B, and if the aggregation of the electrophoretic particle was apparently recognized, and the electrophoretic particles are maldistributed in the electrophoretic dispersion liquid with irregularity, the evaluation was determined as C.

### Evaluation of Electrode Adhesiveness

Two pieces of ITO deposition glass were disposed with a gap of 50 μm therebetween, then a voltage of 15 V was applied across electrodes in a state where the white electrophoretic dispersion liquid and the black electrophoretic dispersion liquid of Example and Comparative Example were added dropwise in the gap, and at that time, the existence of electrophoretic particles adhered to the electrode surface was observed at 200-fold magnification by using a microscope.

As a result, if the electrophoretic particles were not adhered onto the electrode surface in the electrophoretic dispersion liquid, the evaluation was determined as A, if the electrophoretic particles were slightly adhered onto the electrode surface in the electrophoretic dispersion liquid, and the adhesion of the particles onto the electrode surface was eliminated due to the application of voltage, the evaluation was determined as B, and if the electrophoretic particles were apparently adhered onto the electrode surface in the electrophoretic dispersion liquid, and the adhesion of the particles onto the electrode surface was not eliminated due to the application of voltage, the evaluation was determined as C.

The evaluation results are indicated in Tables 4 and 5.

TABLE 4

| | | Block copolymer | | | | | |
|---|---|---|---|---|---|---|---|
| | Particle | | Number | | Number of | Evaluation | |
| | (white | | of first | Second | second | Particle | Electrode |
| | particle) | First monomer | units | monomer | units | aggregation | adhesiveness |
| Example 1B | CR50 | 15k siloxane MA | 1 | KBE-503 | 2 | A | B |
| Example 2B | CR50 | 100k siloxane MA | 1 | KBE-503 | 2 | A | B |
| Comparative | CR50 | 14k siloxane MA | 1 | KBE-503 | 2 | C | C |
| Example 1B | | | | | | | |
| Comparative | CR50 | 160k siloxane MA | 1 | KBE-503 | 2 | C | C |
| Example 2B | | | | | | | |

TABLE 5

| | | Block copolymer | | | | | |
|---|---|---|---|---|---|---|---|
| | Particle | | Number | | Number of | Evaluation | |
| | (black | | of first | Second | second | Particle | Electrode |
| | particle | First monomer | units | monomer | units | aggregation | adhesiveness |
| Example 1B | 13MT | 15k siloxane MA | 1 | KBE-503 | 2 | A | B |
| Example 2B | 13MT | 100k siloxane MA | 1 | KBE-503 | 2 | A | B |
| Comparative | 13MT | 14k siloxane MA | 1 | KBE-503 | 2 | C | C |
| Example 1B | | | | | | | |
| Comparative | 13MT | 160k siloxane MA | 1 | KBE-503 | 2 | C | C |
| Example 2B | | | | | | | |

As apparently indicated in Tables 4 and 5, in the electrophoretic dispersion liquids of the respective Examples, the aggregation of the electrophoretic particles in the white electrophoretic dispersion liquid and black electrophoretic dispersion liquid, and the adhesion of the electrophoretic particles to the electrode were appropriately suppressed, and thus it was found that the electrophoretic particles in the electrophoretic dispersion liquid exhibited the excellent dispersibility and the electrophoretic properties.

In contrast, in the electrophoretic dispersion liquid in Comparative Examples, it was recognized that since the molecular weight of the first unit (the dispersion portion) is within a range of 15,000 to 150,000, it is not possible to contribute the sufficient dispersibility with respect to the electrophoretic particle, and thus the electrophoretic particles are aggregated with each other in the electrophoretic dispersion liquid, and the electrophoretic particles are adhered to the electrode. As a result, it was found that the electrophoretic particles in the electrophoretic dispersion liquid were not excellent in the dispersibility and the phoretic properties.

3-2b. Evaluation of Display Properties

In addition, regarding the electrophoretic dispersion liquid in Examples 1B and 2B and Comparative Examples 1B and 2B, the evaluation of display properties was performed as follows.

### Evaluation of Display Properties

First, regarding the electrophoretic dispersion liquid containing the white particles in Examples 1B and 2B and Comparative Examples 1B and 2B, and the electrophoretic dispersion liquid containing the black particles in Examples 1B and 2B and Comparative Examples 1B and 2B, the electrophoretic dispersion liquid containing the white particle and the black particle was prepared by combining the white particle and the black particle in Examples and Comparative Examples such that the volume ratio of the white electrophoretic dispersion liquid to the black electrophoretic dispersion liquid in the mixture is 10:1.

Then, a transparent electrode cell having the thickness of 50 μm was injected into the prepared electrophoretic dispersion liquid, and then white reflectance at the time of white display, and black reflectance at the time of black display were measured so as to calculate contrasts thereof.

The evaluation results are indicated in Table 6.

TABLE 6

| White electrophoretic | Black electrophoretic | |
|---|---|---|
| dispersion liquid | dispersion liquid | |
| (Content of block | (Content of block | White reflectance/black |
| copolymer) | copolymer) | reflectance |
| Example 1B | Example 1B | 47/3.7 |
| Example 2B | Example 2B | 49/3.2 |
| Comparative | Comparative | 34/5.1 |
| Example 1B | Example 1B | |
| Comparative | Comparative | 34/5.1 |
| Example 2B | Example 2B | |

As apparent from Table 6, in electrophoretic dispersion liquid obtained by combining the white particle and the black particle in the respective Examples, the electrophoretic particle exhibited the excellent contrast, that is, display properties in the electrophoretic dispersion liquid without the aggregation generated between the white particle and the black particle.

In contrast, in the electrophoretic dispersion liquid obtained by combining the white particle and the black particle in the respective Comparative Examples, since the molecular weight of the first unit (the dispersion portion) is not within a range of 15,000 to 150,000, it is not possible to contribute the sufficient dispersibility with respect to the electrophoretic particle, and thus the aggregation is generated between the white particle and the black particle. As a result, it was found that the contrast, that is, the display properties are deteriorated.

The entire disclosure of Japanese Patent Application No. 2015-255352, filed Dec. 25, 2015 is expressly incorporated by reference herein.

What is claimed is:

1. An electrophoretic particle comprising:
a particle; and
a particle surface treatment agent which is bonded to the particle,
wherein the particle surface treatment agent is a block copolymer which includes a dispersion portion derived from one first monomer formed of a siloxane-based compound, and a bonding portion derived from two or more second monomers having a functional group, and is bonded to the particle with the reaction of the functional group in the bonding portion, and
wherein a weight-average molecular weight of the dispersion portion is in a range of 15,000 to 150,000.

2. The electrophoretic particle according to claim 1,
wherein the dispersion portion is formed by bonding the one first monomer to the bonding portion.

3. The electrophoretic particle according to claim 1,
wherein the first monomer is a silicone macromonomer expressed by the following Formula (I). 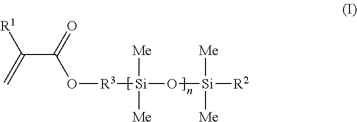
[In the formula, R¹ represents a hydrogen atom or a methyl group, R² represents a hydrogen atom or an alkyl group having 1 to 4 carbon atoms, R³ represents a structure including one of an alkyl group having 1 to 6 carbon atoms and an ether group of ethylene oxide or propylene oxide, and n represents an integer of 180 or greater.]

4. The electrophoretic particle according to claim 1,
wherein the bonding portion is formed by polymerizing the two or more second monomers.

5. The electrophoretic particle according to claim 1,
wherein in the bonding portion, the number of units derived from the second monomer is in a range of 2 to 15.

6. The electrophoretic particle according to claim 1,
wherein in a case where a weight of the particle is set to be 100% by weight, the weight of the particle surface treatment agent is in a range of 2% by weight to 20% by weight.

7. An electrophoretic dispersion liquid comprising:
the electrophoretic particle according to claim 1; and
a dispersion medium having a silicone oil as a main component.

8. An electrophoretic dispersion liquid comprising:
the electrophoretic particle according to claim 2; and
a dispersion medium having a silicone oil as a main component.

9. An electrophoretic dispersion liquid comprising:
the electrophoretic particle according to claim 3; and
a dispersion medium having a silicone oil as a main component.

10. An electrophoretic dispersion liquid comprising:
the electrophoretic particle according to claim 4; and
a dispersion medium having a silicone oil as a main component.

11. An electrophoretic dispersion liquid comprising:
the electrophoretic particle according to claim 5; and
a dispersion medium having a silicone oil as a main component.

12. An electrophoretic dispersion liquid comprising:
the electrophoretic particle according to claim 6; and
a dispersion medium having a silicone oil as a main component.

13. An electrophoretic sheet comprising:
a substrate; and
a structure body which is provided on the substrate and accommodates the electrophoretic dispersion liquid according to claim 7.

14. An electrophoretic sheet comprising:
a substrate; and
a structure body which is provided on the substrate and accommodates the electrophoretic dispersion liquid according to claim 8.

15. An electrophoretic sheet comprising:
a substrate; and
a structure body which is provided on the substrate and accommodates the electrophoretic dispersion liquid according to claim 9.

16. An electrophoretic sheet comprising:
a substrate; and
a structure body which is provided on the substrate and accommodates the electrophoretic dispersion liquid according to claim 10.

17. An electrophoretic sheet comprising:
a substrate; and
a structure body which is provided on the substrate and accommodates the electrophoretic dispersion liquid according to claim 11.

18. An electrophoretic sheet comprising:
a substrate; and
a structure body which is provided on the substrate and accommodates the electrophoretic dispersion liquid according to claim 12.

19. An electrophoretic device comprising the the electrophoretic sheet according to claim 13.

20. An electronic apparatus comprising the the electrophoretic device according to claim 19.
